(19) United States
(12) Patent Application Publication
(10) Pub. No.: US 2023/0207929 A1
(43) Pub. Date: Jun. 29, 2023

(54) SECONDARY BATTERY

(71) Applicant: Samsung SDI Co., Ltd., Yongin-si (KR)

(72) Inventor: Hyun Soo LEE, Yongin-si (KR)

(21) Appl. No.: 17/954,255

(22) Filed: Sep. 27, 2022

(30) Foreign Application Priority Data
Dec. 29, 2021 (KR) 10-2021-0191202

(51) Int. Cl. H01M 50/103; H01M 50/176; H01M 50/548; H01M 50/342

(52) U.S. Cl. CPC H01M 50/103; H01M 50/176; H01M 50/548; H01M 50/3425

(57) ABSTRACT

A secondary battery includes: an electrode assembly comprising a first electrode plate, a second electrode plate, and a separator between the first electrode plate and the second electrode plate; a can accommodating the electrode assembly and having a pipe shape and having a thickness varying along a circumference; a first side plate sealing a first end of the can; a second side plate sealing a second end of the can; a first side terminal electrically connected to the first electrode plate and exposed to the outside through the first side plate; and a second side terminal electrically connected to the second electrode plate and exposed to the outside through the second side plate.

### CROSS-REFERENCE TO RELATED APPLICATION

The present application claims priority to and the benefit of Korean Patent Application No. 10-2021-0191202 filed on Dec. 29, 2021 in the Korean Intellectual Property Office, the entire content of is incorporated herein by reference.

### BACKGROUND

### 1. Field

Aspects of some embodiments of the present disclosure relate to a secondary battery.

### 2. Description of the Related Art

Unlike a primary battery that cannot be charged, a secondary battery is battery that can generally be repeatedly charged and discharged. A low-capacity secondary battery may include one single cell packaged in the form of a pack, and may be used for various portable small-sized electronic devices, such as cellular phones or camcorders, and a high-capacity secondary battery in which several tens of cells are connected in a battery pack is widely used as a power source for motor drives, such as those in hybrid vehicles or electric vehicles. Such secondary batteries may be classified into a cylindrical battery, a prismatic battery, a pouch-type (or polymer-type) battery, and the like, according to their external appearance. For example, the prismatic battery may be formed by incorporating into a can an electrode assembly formed with a separator interposed between a positive electrode plate and a negative electrode plate, an electrolyte, and the like, and installing a cap plate in the can.

The above information disclosed in this Background section is only for enhancement of understanding of the background and therefore the information discussed in this Background section does not necessarily constitute prior art.

### SUMMARY

Aspects of some embodiments of the present disclosure include a secondary battery which can be relatively easily manufactured.

In addition, aspects of some embodiments of the present disclosure include a secondary battery having excellent stability.

A secondary battery according to some embodiments of the present disclosure may include an electrode assembly comprising a first electrode plate, a second electrode plate, and a separator interposed between the first electrode plate and the second electrode plate, a can for accommodating the electrode assembly, the can formed in a pipe shape and having a thickness varying along the circumferential direction, a first side plate for sealing an open end of the can, a second side plate for sealing the other open end of the can, a first side terminal electrically connected to the first electrode plate and exposed to the outside through the first side plate, and a second side terminal electrically connected to the second electrode plate and exposed to the outside through the second side plate.

According to some embodiments, the can may be formed in a rectangular pipe shape, and may have a first short side, a second short side, a first long side, and a second long side.

According to some embodiments, the thickness of each of the first short side and the second short side may be greater than the thickness of each of the first long side and the second long side.

According to some embodiments, a safety vent may be positioned on the second short side, and the thickness of the second short side may be greater than the thickness of each of the first short side, the first long side, and the second long side.

According to some embodiments, a hole may be formed in the second short side, and the safety vent may be on the hole to be fixed by lap welding.

### BRIEF DESCRIPTION OF DRAWINGS

FIG. 1 is a perspective view of a secondary battery according to some embodiments of the present disclosure.

FIG. 2 is a front view of a secondary battery according to some embodiments of the present disclosure.

FIG. 3 is a plan view of a secondary battery according to some embodiments of the present disclosure.

FIG. 4 is a bottom view of a secondary battery according to some embodiments of the present disclosure.

FIG. 5 is a left side view of a secondary battery according to some embodiments of the present disclosure.

FIG. 6 is a right side view of a secondary battery according to some embodiments of the present disclosure.

FIG. 7 is a cross-sectional view of a can of a secondary battery according to some embodiments of the present disclosure, taken along the line 7-7 in FIG. 1.

FIG. 8 is a schematic diagram of a process of manufacturing a can of a secondary battery according to some embodiments of the present disclosure.

### DETAILED DESCRIPTION

Hereinafter, preferred embodiments of the present invention will be described in detail with reference to the accompanying drawings.

Examples of the present invention are provided to more completely explain the present invention to those skilled in the art, and the following examples may be modified in various other forms. The present invention, however, may be embodied in many different forms and should not be construed as being limited to the example (or illustrated) embodiments set forth herein. Rather, these example embodiments are provided so that this disclosure will be thorough and complete and will convey the aspects and features of the present invention to those skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise” and/or “comprising” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the term “below” can encompass both an orientation of above and below.

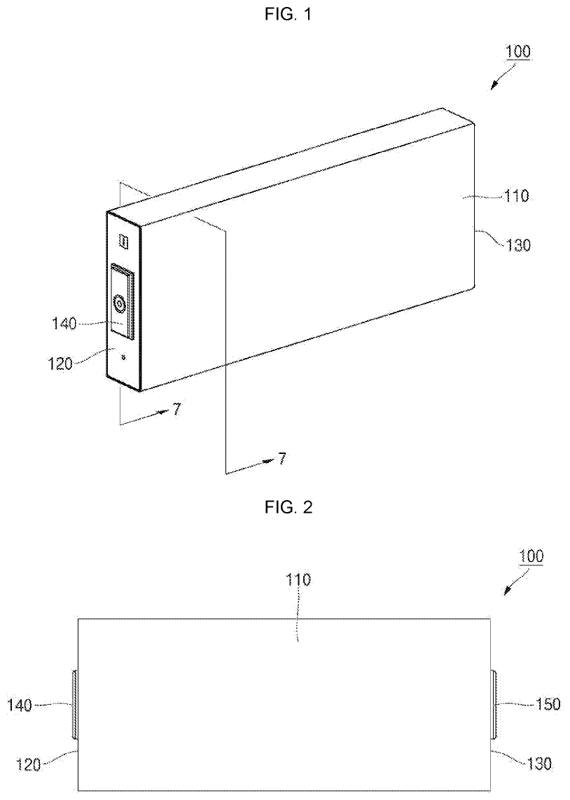

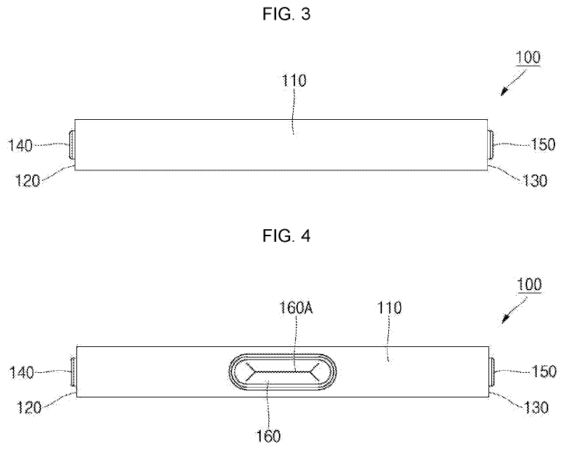

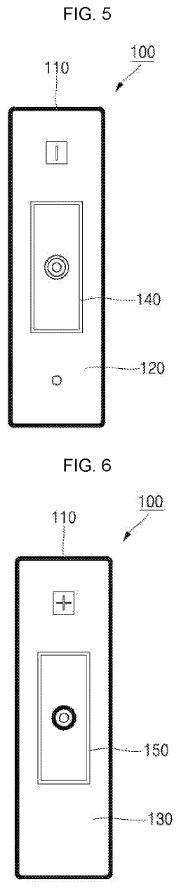

FIG. 1 is a perspective view of a secondary battery 100 according to some embodiments of the present disclosure, FIG. 2 is a front view of the secondary battery 100 according to some embodiments of the present disclosure, FIG. 3 is a plan view of the a secondary battery 100 according to some embodiments of the present disclosure, FIG. 4 is a bottom view of the secondary battery 100 according to some embodiments of the present disclosure, FIG. 5 is a left side view of the secondary battery 100 according to some embodiments of the present disclosure, and FIG. 6 is a right side view of the secondary battery 100 according to some embodiments of the present disclosure.

Referring to FIGS. 1 to 6, the secondary battery 100 according to some embodiments of the present disclosure includes an electrode assembly, a can 110, a first side plate 120, a second side plate 130, a first side terminal 140, and a second side terminal 150. The electrode assembly according to some embodiments may be located inside the can 110.

The electrode assembly includes a first electrode plate, a second electrode plate, and a separator.

The first electrode plate may be any one of a negative electrode plate and a positive electrode plate. For example, when the first electrode plate is a negative electrode plate, the first electrode plate may include a negative electrode coated portion that is coated with a negative electrode active material and a negative electrode uncoated portion that is not coated with a negative electrode active material, on a negative electrode current collector plate made of a conductive metal thin plate, for example, copper or nickel foil or mesh. The negative electrode active material may include, for example, a carbon-based material, Si, Sn, tin oxide, a tin alloy composite, transition metal oxide, lithium metal nitrite, or metal oxide.

The second electrode plate may be the other one of a negative electrode plate and a positive electrode plate. For example, when the second electrode plate is a positive electrode plate, the second electrode plate may include a positive electrode coated portion that is coated with a positive electrode active material and a positive electrode uncoated portion that is not coated with a positive electrode active material, on a positive electrode current collector plate made of a thin conductive metal plate, for example, aluminum foil or mesh. The positive electrode active material may include a chalcogenide compound, for example, a composite metal oxide, such as LiCoO₂, LiMn₂O₄, LiNiO₂, LiNiMnO₂, or the like.

The separator is interposed between the first electrode plate and the second electrode plate, and serves to prevent an electrical short between the first electrode plate and the second electrode plate. The separator may be made of, for example, polyethylene, polypropylene, a porous copolymer of polyethylene and polypropylene, or the like.

The can 110 serves to accommodate the electrode assembly and an electrolyte.

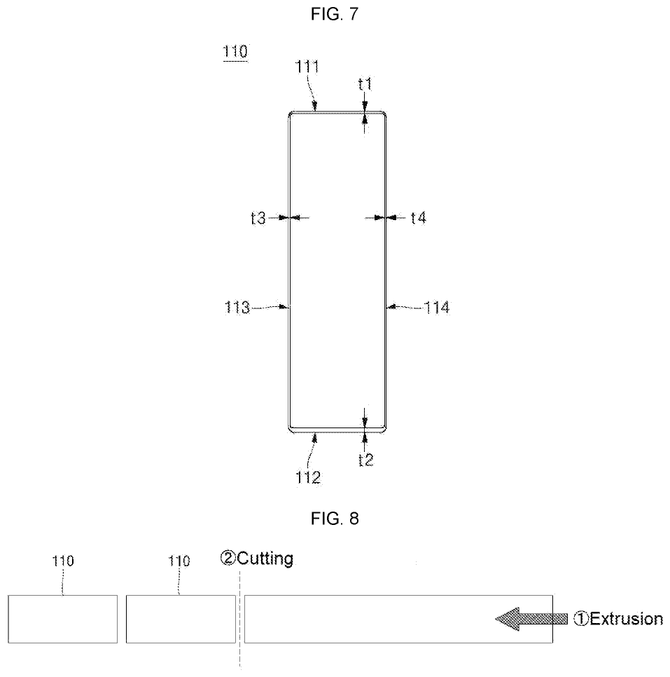

Referring to FIG. 7, which is a cross-sectional view of the can 110 of the secondary battery 100 according to some embodiments of the present disclosure, taken along the line 7-7 in FIG. 1, the can 110 is formed in a pipe shape (e.g., a tube or conduit shape). For example, in the drawings, the can 110 is shown by way of example as being formed in a rectangular pipe shape (e.g., a tube having a rectangular cross-section). Hereinafter, in the can 110, two regions having relatively short sides are referred to as a first short side 111 and a second short side 112, respectively, and two regions having relatively long sides are referred to as a first long side 113 and a second long side 114, respectively.

In this case, the thicknesses t1 and t2 of the first short side 111 and the second short side 112 are greater than the thicknesses t3 and t4 of the first long side 113 and the second long side 114. Accordingly, with respect to the first short side 111 and the second short side 112, the rigidity and cooling efficiency may be improved.

Meanwhile, the safety vent 160 may be positioned on the second short side 112. When gas is generated inside the can 110, the safety vent 160 is automatically ruptured by the pressure due to the generated gas to release the gas and pressure, thereby preventing the secondary battery 100 from exploding. To this end, the safety vent 160 may have a notch 160A formed to induce rupture. The safety vent 160 may have a hole formed through the second short side 112 and may be located on the hole to then be fixed by lap welding. Here, the thickness t2 of the second short side 112 is preferably greater than the thickness t1 of the first short side 111. Accordingly, by reinforcing rigidity through a relatively large thickness, it is possible to prevent the second short side 112 from being unintentionally deformed during lap welding.

According to some embodiments, when the can 110 is formed in a rectangular pipe shape and the safety vent 160 is positioned on the second short side 112, the thickness t2 of the second short side 112 is largest, and the thickness t1 of the first short side 111 may be greater than the thicknesses t3 and t4 of the first and second long sides 114. Thus, the thickness of the can 110 along the circumference (e.g., the edges in a cross section) or a circumferential direction, may vary.

In order to describe a method of manufacturing the can 110, reference is made to FIG. 8, which is a schematic diagram of a process of manufacturing a can of a secondary battery according to some embodiments of the present disclosure, and the can 110 may be formed by being molded into one long rectangular pipe by an extrusion process and then cut to a certain length. Here, through a gap between a square die and a square mandrel, the thicknesses of the first short side 111, the second short side 112, the first long side 113, and the second long side 114 can be easily set.

The first side plate 120 is formed in a square plate shape to correspond to the open end of the can 110. Accordingly, the first side plate 120 is welded to one end of the can 110 and serves to seal.

The second side plate 130 is formed in a square plate shape to correspond to the other open end of the can 110. Accordingly, the second side plate 130 is welded to the other end of the can 110 and serves to seal.

The first side terminal 140 is electrically connected to a negative electrode uncoated portion of the first electrode plate of the electrode assembly, passes through the first side plate 120 and is exposed to the outside. Accordingly, the first side terminal 140 serves as a negative electrode terminal. In this case, an insulating member is provided between the first side terminal 140 and the first side plate 120 to prevent an electrical short therebetween.

The second side terminal 150 is electrically connected to a positive electrode uncoated portion of the second electrode plate of the electrode assembly, penetrates the second side plate 130 and is exposed to the outside. Accordingly, the second side terminal 150 serves as a positive electrode terminal. In this case, an insulating member is provided between the second side terminal 150 and the second side plate 130 to prevent an electrical short therebetween.

In the above-described secondary battery, since the negative electrode terminal (first side terminal) and the positive electrode terminal (second side terminal) are provided on the left and right sides, the upper and lower portions thereof can be effectively cooled at the same time. In the case of a conventional prismatic battery, since a negative electrode terminal and a positive electrode terminal are provided on the upper portion thereof, there is a disadvantage in that the upper portion is difficult to cool.

In addition, in the case of a conventional prismatic battery, since a negative electrode terminal and a positive electrode terminal are provided on the upper portion thereof, there is a limitation in utilizing an upper space. In contrast, in the above-described secondary battery, since the negative electrode terminal (first side terminal) and the positive electrode terminal (second side terminal) are provided on the left and right sides, an upper space thereof can be efficiently used.

In addition, in the case of a conventional prismatic battery, since a negative electrode terminal and a positive electrode terminal are provided on the upper portion thereof, charging/discharging current flows in an approximately U-shape, and thus there is a problem in that a specific area is rapidly deteriorated. However, in the above-described secondary battery, since the negative electrode terminal (first side terminal) and the positive electrode terminal (second side terminal) are provided on the left and right sides, charging/discharging current flows in the horizontal direction, thereby suppressing battery deterioration.

As described above, some embodiments of the present disclosure may include a secondary battery which can be relatively easily manufactured by manufacturing a can by forming a single long rectangular pipe through an extrusion process and cutting the same to a length (e.g., a set or predetermined length).

Here, by forming the short side more thickly than the long side, the rigidity and cooling efficiency can be improved.

For example, by forming the short side on which the safety vent is positioned most thickly, the structural stability when the safety vent is installed can be reinforced.

While the foregoing describes aspects of some embodiments for carrying out the secondary battery according to the present disclosure, embodiments according to the present disclosure are not limited thereto, and it will be understood by a person skilled in the art that various changes in form and details may be made therein without departing from the spirit and scope of embodiments according to the present disclosure as defined by the following claims, and their equivalents.

What is claimed is:

1. A secondary battery comprising:
an electrode assembly comprising a first electrode plate, a second electrode plate, and a separator between the first electrode plate and the second electrode plate;
a can accommodating the electrode assembly and having a pipe shape and having a thickness varying along a circumference of the pipe shape;
a first side plate sealing a first end of the can;
a second side plate sealing a second end of the can;
a first side terminal electrically connected to the first electrode plate and exposed to the outside through the first side plate; and
a second side terminal electrically connected to the second electrode plate and exposed to the outside through the second side plate.

2. The secondary battery of claim 1, wherein the can is formed in a rectangular pipe shape, and has a first short side, a second short side, a first long side, and a second long side.

3. The secondary battery of claim 2, wherein the thickness of each of the first short side and the second short side is greater than the thickness of each of the first long side and the second long side.

4. The secondary battery of claim 2, wherein a safety vent is on the second short side, and the thickness of the second short side is greater than the thickness of each of the first short side, the first long side, or the second long side.

5. The secondary battery of claim 4, wherein a hole is formed in the second short side, and the safety vent is on the hole to be fixed by lap welding.
